(19) United States
(12) Patent Application Publication
(10) Pub. No.: US 2014/0028904 A1
(43) Pub. Date: Jan. 30, 2014

(54) CAMERA MODULE

(71) Applicants: Seong Ho KANG, Seongnam-si (KR); Myung Jin LEE, Suwon-si (KR); Jae Ho BAIK, Busan (KR)

(72) Inventors: Seong Ho KANG, Seongnam-si (KR); Myung Jin LEE, Suwon-si (KR); Jae Ho BAIK, Busan (KR)

(73) Assignee: SAMSUNG ELECTRO-MECHANICS CO., LTD., Suwon (KR)

(21) Appl. No.: 13/740,056

(22) Filed: Jan. 11, 2013

(30) Foreign Application Priority Data
Mar. 23, 2010 (KR) 10-2010-0025848

(51) Int. Cl. H04N 5/225

(52) U.S. Cl. CPC H04N 5/2254
USPC 348/374

(57) ABSTRACT

Disclosed herein is a camera module. The camera module includes: a lens barrel with a built-in lens collecting external images; a housing that has a receiving space in which the lens barrel is received; a driving part that is configured to include a magnet and a coil and provides a first driving force that drives the lens barrel upward and a second driving force that drives the lens barrel downward by an electromagnetic force that is generated from the magnet and the coil; a guide ball that is provided between the lens barrel and the housing and guides the motion of the lens barrel; and a position detection part that senses the position of the lens barrel, wherein the driving part drives the lens barrel upward and downward so that a preload part that provides preload returning the lens barrel to its initial position is not required.

### CROSS REFERENCE TO RELATED APPLICATION

This application is a continuation of U.S. patent application Ser. No. 12/849,734, filed Aug. 3, 2010 entitled “Camera Module” which claims the benefit of Korean Patent Application No. 10-2010-0025848, filed on Mar. 23, 2010, entitled “Camera Module”, which is hereby incorporated by reference in its entirety into this application.

### BACKGROUND OF THE INVENTION

1. Technical Field

The present invention relates to a camera module.

2. Description of the Related Art

In general, electronic equipment or a personal portable terminal such as a cellular phone, a PDA, and the like is added with additional functions other than the main functions. Presently, a lot of electronic equipment that include a camera function have become popular among consumers. Therefore, a market for camera modules that are mounted in the electronic equipment have also expanded.

According to recent market demands, a camera module has been correspondingly developed to gradually include additional functions such as autofocus, optical zoom, optical image stabilization (OIS) and the like other than simple functions such as fixed focus.

In particular, in order that the additional functions such as autofocus, optical zoom, OIS, and the like are accomplished in the camera module, the camera module must be provided with a lens driving module using an actuator that can drive lens.

In general, a camera module provided with a voice coil motor (VCM)-type lens driving module has been used. FIG. 1 shows a cross-sectional view of a camera module according to the related art, FIG. 2 shows a cross-sectional view showing the use of the camera module of FIG. 1, and FIG. 3 shows a displacement graph of a lens barrel with respect to when current is applied to the coil of the camera module of FIG. 1.

As shown in FIG. 1, the camera module 10 according to the related art includes a lens barrel 20 that is mounted with a group of lens 22 including a plurality of lenses and is driven in the direction of an optical axis, a fixing part 30 in which the lens barrel 20 is received, a leaf spring (preload part) 40, and an actuator that includes a magnet 52 and a coil 54 and generates force (electromagnetic force) that drives the lens barrel 20 in the direction of an optical axis. At this time, the magnet 52 is fixed on the inner circumferential surface of the fixing part 30 through a yoke 56 and the coil 54 is provided on the outer circumferential surface of the lens barrel 20.

In the camera module 10 having the configuration described above, when current is not applied to the coil 54, the lens barrel 20 is positioned at the initial position, and when current is applied to the coil 54, the lens barrel 20 is raised by electromagnetic force which is generated by the interaction between the coil 54 and the magnet 52 to perform an autofocus function (see FIG. 2). When the supply of current is stopped, the raised lens barrel 20 is returned to the initial position by the restoring force (preload) of the leaf spring 40.

However, the camera module 10 according to the related art, using the driving principle described above, has a lot of power consumption due to the leaf spring 40 that restores the lens barrel 20 to the initial position. Referring to FIG. 3, it can be appreciated that after current is applied to the coil 54 and only when force greater than the sum of weight M of the lens barrel 20 and the preload K is applied to the lens barrel 20, the lens barrel 20 is driven upward. That is, a large amount of current cannot but be applied to the coil 54 due to the preload K in order to drive the lens barrel 20, such that high power consumption occurs.

In addition, the leaf spring 40 makes the structure and manufacturing process complicated. Further, the preload K of the leaf spring 40 is changed according to the position of the lens barrel 20, such that the current applied to the coil 54 should be controlled in consideration thereof, thereby degrading driving reliability.

In addition, the lens barrel 20 is tilted from the direction of the optical axis according to the coupling state of the lens barrel 20 and the leaf spring 40, while having a difficulty in controlling thereof.

In addition, there is no structure for reducing shaking of the lens barrel 20 due to external impact or self-vibration thereof when driving the lens barrel 20 upward and downward, such that it is difficult to improve operational performance of the lens barrel.

### SUMMARY OF THE INVENTION

The present invention has been made in an effort to provide a camera module that can minimize power consumption and tilt phenomenon of a lens barrel and improve driving reliability by removing a preload part, and reduce self-vibration thereof at the time of driving the lens barrel by coupling damping members.

A camera module according to an exemplary embodiment of the present invention includes: a lens barrel with a built-in lens collecting external images; a housing that has a receiving space in which the lens barrel is received; a driving part that is configured to include a magnet and a coil and provides a first driving force that drives the lens barrel upward and a second driving force that drives the lens barrel downward by an electromagnetic force that is generated from the magnet and the coil; a guide ball that is provided between the lens barrel and the housing and guides the motion of the lens barrel; and a position detection part that senses the position of the lens barrel.

Herein, damping member that reduce vibration of the lens barrel are formed on the upper portion or the lower portion of the lens barrel.

Further, a damping coupling part is further formed on the outer circumferential surface of the lens barrel in order to support the damping members.

Further, the lens barrel starts to be driven upward and downward by the driving part at any positions in the receiving space of the housing.

Further, when the first driving force is larger than the weight of the lens barrel, the lens barrel is driven upward, and when the second driving force that is smaller than the first driving force is applied, the lens barrel is driven downward.

Further, the first driving force is larger than the second driving force.

Further, the driving part includes the coil that is mounted on the inner circumferential surface of the housing and generates an electric field when current is applied; and the magnet that is mounted on the outer circumferential surface of the lens barrel so as to be opposite to the coil and generates a magnetic field interacting with the electric field.

Further, receiving grooves that rotatably support the guide ball are formed on the outer circumferential surface of the lens barrel and the inner circumferential surface of the housing.

Further, the position detection part is a hole sensor that senses the change in the position of the magnet.

Further, the camera module further includes a control part that calculates a focusing target position of the lens barrel from an image signal of an image sensor mounted on a circuit substrate having the housing attached and fixed on its upper surface, compares the focusing target position with a driving position of the lens barrel sensed by the position detection part, and controls power applied to the lens barrel.

### BRIEF DESCRIPTION OF THE DRAWINGS

FIG. 1 is a cross-sectional view of a camera module according to the related art;

FIG. 2 is a cross-sectional view showing the use of the camera module of FIG. 1;

FIG. 3 is a displacement graph of a lens barrel with respect to when current is applied to the coil of the camera module of FIG. 1;

FIG. 4 is a longitudinal cross-sectional view of a camera module according to an exemplary embodiment of the present invention;

FIG. 5 is a cut perspective view showing the camera module of FIG. 4;

FIG. 6 is a diagram showing the driving principle of the camera module of FIGS. 4 and 5;

FIG. 7 is a graph showing the relationship between current applied to the driving part and the displacement of the lens barrel of the camera module of FIGS. 4 and 5; and

FIG. 8A is a diagram showing a configuration when a damping member according to an exemplary embodiment of the present invention is coupled to the upper portion of the lens barrel, and FIG. 8B is a diagram showing a configuration where a damping member according to another embodiment of the present invention is coupled to the lower portion of the lens barrel.

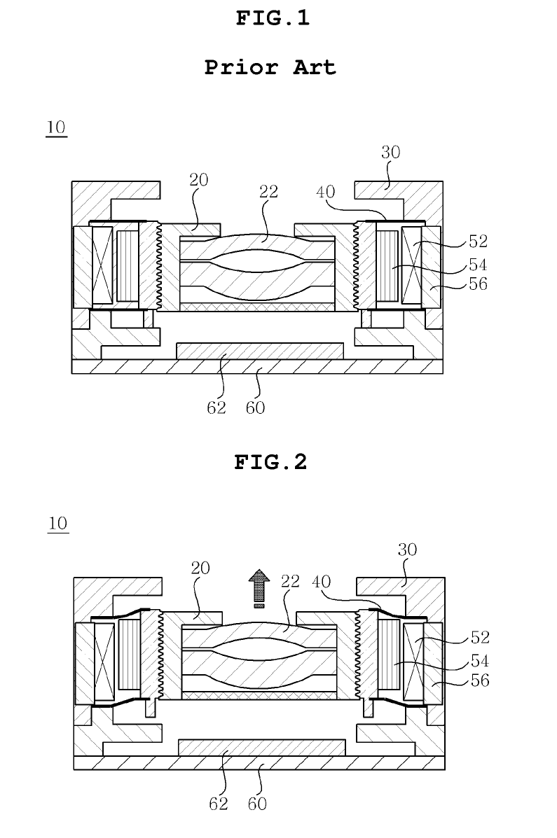

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, exemplary embodiments of the present invention will be described in detail with reference to the accompanying drawings.

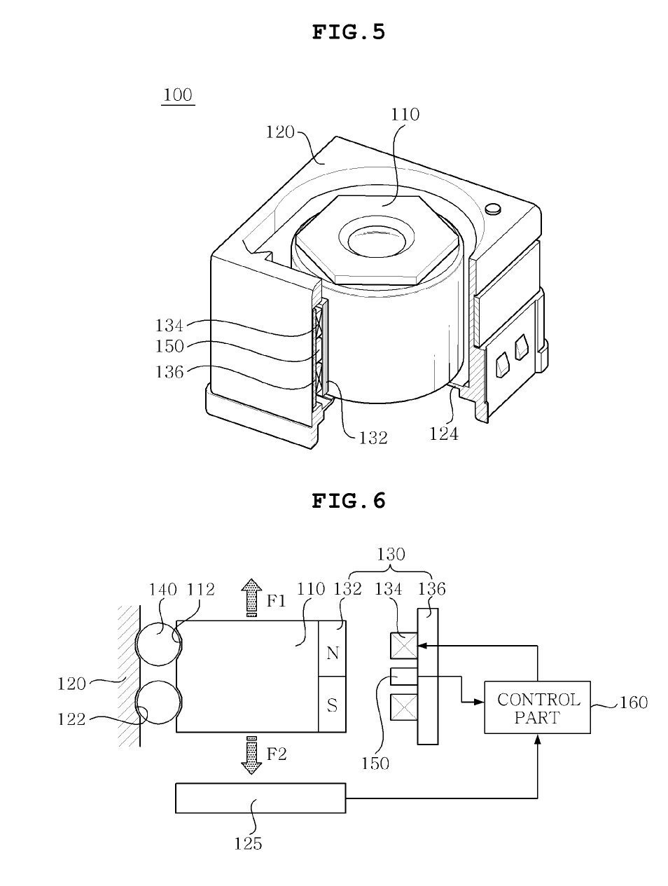

FIG. 4 is a longitudinal cross-sectional view of a camera module according to an exemplary embodiment of the present invention, and FIG. 5 is a partially cut perspective view showing the camera module of FIG. 4. Hereinafter, the camera module 100 according to the present embodiment will be described with reference to FIGS. 4 and 5.

As shown in FIGS. 4 and 5, the camera module 100 according to the exemplary embodiment of the present invention includes a lens barrel 110, a housing 120, a driving part 130, a guide ball 140, and a position detection part 150.

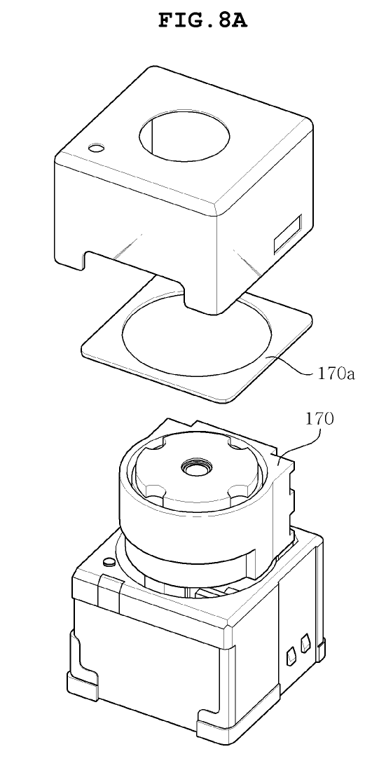

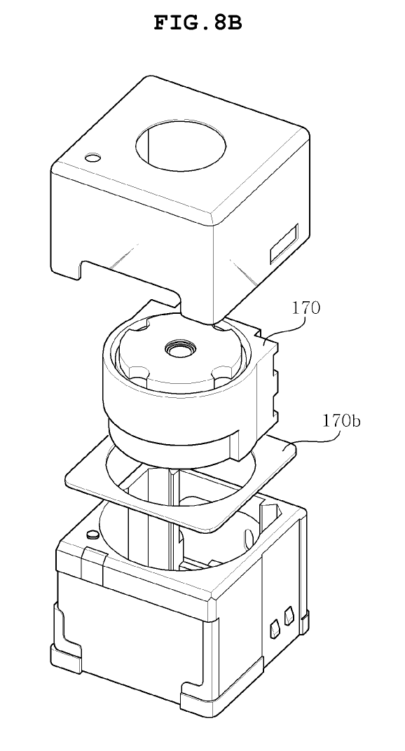

As shown in FIGS. 8A and 8B, the camera module 100 may further include a damping coupling part 170 that couples damping members 170a and 170b in order to reduce the vibration of the lens barrel 110.

The lens barrel 110 collects external images to the inside of the camera module through a lens L. The lens barrel 110 is configured to include a hollow cylindrical lens receiving body having a predetermined internal space size so that at least one lens L is disposed according to the optical axis and controls focal length, while vertically driving in the direction of the optical axis.

Herein, the lens barrel 110 is positioned at any positions inside the receiving space of the housing 120 that receives and supports the lens barrel 110. The lens barrel 110 positioned at any positions starts to be vertically driven in the direction of the optical axis by the driving part 130 to adjust the focal length. The driving part 130 will be described later.

Herein, the lens barrel 110 includes a spacer (not shown) in order to ensure predetermined intervals provided among a plurality of lenses disposed therein, such that a predetermined size of an incident hole (having no reference numeral) that matches the center of the lens is penetrated through the upper portion of the lens barrel 110.

Further, a magnet 132 that generates a magnetic field is provided on one side of the outer circumferential surface of the lens barrel 110 and it will be described in detail in a description regarding the driving part 130.

Further, it is preferable that a first receiving groove 112 in which at least a portion of the guide ball 140 is received is formed on the other side of the outer circumferential surface of the lens barrel 110 (see FIG. 6). At this time, the first receiving groove 112 is provided on the outer circumferential surface of the lens barrel 110 in which the magnet 132 is not provided so as to correspond to the number and the disposition of the guide ball 140.

When the lens barrel 110 is vertically driven in the direction of the optical axis, the damping members 170a and 170b reduces the self-vibration of the lens barrel 110 or the vibration thereof due to surrounding impacts. The damping members 170a and 170b may be formed as the upper damping member 170a and the lower damping member 170b on the upper portion and the lower portion of the lens barrel 110, respectively. Further, it is obvious that all the damping members 170a and 170b may be formed on the lower portion and the upper portion of the lens barrel 110.

The damping coupling part 170 is formed on the outer circumferential surface of the lens barrel 110, while the shapes correspondingly match the damping members 170a and 170b, so as to support the damping members 170a and 170b. The damping members 170a and 170b are supported and fixed by the damping coupling part 170, such that the self-vibration of the lens barrel 110 or the vibration thereof due to surrounding impact can be reduced by the damping members 170a and 170b.

The housing 120 is an assembly receiving body that receives and supports the lens barrel 110. The housing 120 has an entirely rectangular box shape and an internal hole in the shape corresponding to the external appearance of the lens barrel 110 that is penetrated through the center of the body, the lens barrel 110 being received in the internal space.

Herein, the housing 120 is adhesively fixed on the upper surface of a circuit substrate 125 having the image sensor 126 mounted on the center thereof using adhesives such as a UV curing agent. Further, a step jaw part 124 that functions as a stopper preventing the lower portion of the lens barrel 110 from being detached when the lens barrel 110 descends is provided in the internal space of the housing 120. At this time, it is preferable that an IR filter 128 that filters infrared rays included in light incident through the lens barrel 110 or prevents foreign substances separate from the lens barrel 110 from falling toward the image sensor 126 is mounted on the lower surface of the step jaw part 124.

Further, a coil 134 is provided on the inner circumferential surface of the housing 120 so as to be opposite to the magnet 132 provided on the outer circumferential surface of the lens barrel 110.

Further, it is preferable that a second receiving groove 122 that rotatably supports the guide ball 140 assisting the lens barrel 110 to vertically transfer by reducing a friction force between the lens barrel 110 and the housing 120 is formed on the inner circumferential surface of the housing 120. At this time, the second receiving groove 122 is provided on the inner circumferential surface of the housing 120 in which the coil 134 is not provided, so as to be opposite to the first receiving groove 112.

The driving part 130 generates driving force that vertically drives the lens barrel 110. The driving part 130 drives the lens barrel 110 by electromagnetic force (Lorentz force) between the magnet 132 and the coil 134.

Herein, the driving part 130 generates a first driving force F1 that drives the lens barrel 110 upward and a second driving force F2 that drives the lens barrel 110 downward (see FIG. 6). In other words, in the present invention, the lens barrel 110 is vertically driven by the driving part 130, without using the preload part such as the leaf spring in the related art. At this time, owing to the absence of the preload (restoring force) by the preload part, when the first driving force F1 that drives the lens barrel 110 upward is larger than the weight of the lens barrel 110, the lens barrel 110 is driven upward, thereby making it possible to minimize power consumption as compared to the related art. Meanwhile, the second driving force F2 that drives the lens barrel 110 downward is generated downward by the weight of the lens barrel 110, thereby making it possible to drive the lens barrel 110 downward despite being smaller than the first driving force F1.

At this time, for example, the driving part 130 is configured to include the magnet 132 that is provided on the outer circumferential surface of the lens barrel 110 and the coil 134 that is provided on the inner circumferential surface of the housing 120 so as to be opposite thereto. At this time, a yoke 136 is provided on the inner circumferential surface of the housing 120 in order to induce an electric field generated from the coil 134 in the direction of the magnet 132, wherein it is preferable that the coil 134 is provided on the yoke 136. Meanwhile, the positions of the magnet 132 and the coil 134 may be changed.

The guide ball 140 guides the upward/downward driving of the lens barrel 110 with respect to the housing 120. The guide ball 140 is interposed between the lens barrel 110 and the housing 120 to guide the lens barrel 110 by a rotational motion. At this time, the guide ball 140 minimizes the contact area between the lens barrel 110 and the housing 120 to reduce a friction force, thereby assisting the lens barrel 110 to be vertically driven.

Herein, one portion of the guide ball 140 is rotatably supported, while being received in the first receiving groove 112 of the lens barrel 110, and the other portion thereof is rotatably supported, while being received in the second receiving groove 122 of the housing 120. At this time, the guide ball 140 is contacted and supported by the housing 120, thereby not allowing the lens barrel 110 to be tilted but to be driven in a straight line.

At this time, it is preferable that the guide ball 140 is interposed in the space between the lens barrel 110, on which the magnet 132 or the coil 134 is not provided, and the housing 120. Further, the guide ball 140 may be provided in plural, as needed.

Meanwhile, the guide ball 140 guides the lens barrel 110, while reducing a friction force by a rotational movement, such that it should be understand as a concept including other parts that can accomplish such a function.

The position detection part 150 detects the driving position of the lens barrel. For example, it is preferable that the position detection part 150 is a hole sensor that senses the change of a magnetic force generated from the magnet 132 to sense the driving position of the lens barrel 110.

At this time, the position detection part 150 may, for example, be formed in a shape that it is provided between the coils 134 interposed on the inner circumferential surface of the housing 120, that is, surrounded by the coils 134.

FIG. 6 is a diagram showing the driving principle of the camera module of FIGS. 4 and 5, and FIG. 7 is a graph showing the relationship between current applied to the driving part and the displacement of the lens barrel of the camera module of FIGS. 4 and 5. Hereinafter, the driving principle of the camera module 100 according to an exemplary embodiment of the present invention will be described with reference to these drawings.

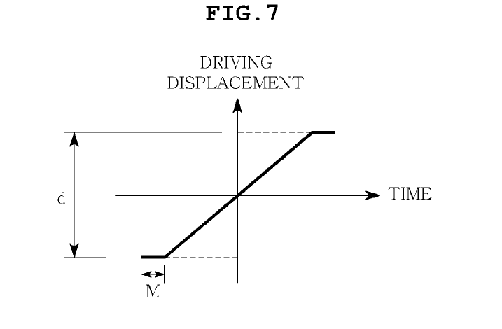

As shown in FIGS. 6 and 7, the driving position of the lens barrel 110 sensed by the position detection part 150 is compared with a focusing target position of the lens barrel 110 calculated from the image signal of the image sensor 126 in the control part 160, and the control part 160 calculates the driving displacement which makes the lens barrel 110 arrive the focusing target position from the comparison results and controls the amount of power (current) necessary for generating the driving displacement to supply it to the coil 134, thereby controlling the driving displacement of the lens barrel 110.

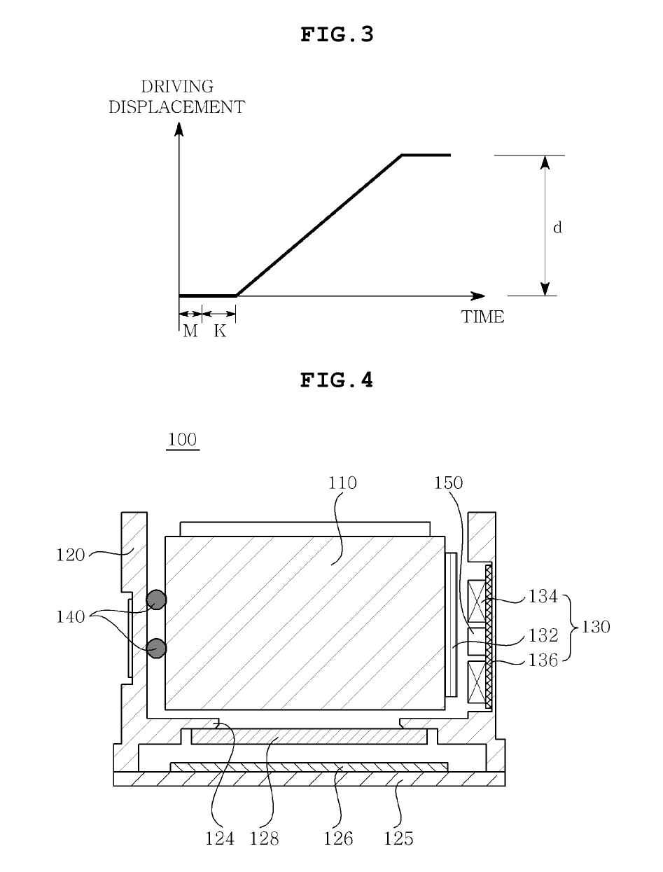

At this time, in the present invention, owing to the absence of the preload part as shown in the related art, the first driving force F1 larger than the weight M of the lens barrel 110 is applied in order to raise the lens barrel 110, thereby making it possible to drive the lens barrel 110 upward. Therefore, the current value M+K necessary at the time of the initial driving in the displacement graph of the lens barrel 110 for the current applied to the camera module according to the related art in FIG. 3 is smaller than the current value M necessary at the time of the initial driving according to the present invention in FIG. 7, such that the current consumption according to the initial driving of the lens barrel 110 is reduced. In addition, owing to the absence of the preload part, the lens barrel 110 is positioned at any positions in the receiving space of the housing 120 to start to be driven by the driving part 130. At the time of initial driving of the lens barrel 110, the amount of current supplied to the coil 134 is in proportion to the driving displacement of the lens barrel 110, thereby making it possible to control the first driving force F1 and the second driving force F2 that raise the lens barrel 110 by controlling the amount of current supplied to the coil 134. As described above, the driving position of the lens barrel 110 is controlled by the first driving force F1 and the second driving force F2 is controlled, thereby making it possible to provide an autofocus function of the lens barrel 110 at a precision position.

According to the present invention, the driving part provides the first and second driving forces that drive the lens barrel upward and downward and drives the lens barrel upward and downward, thereby making it possible to perform an accurate autofocus function of the lens barrel. At this time, the preload part that provides preload (the driving force descending the lens barrel) returning the lens barrel to the initial position is not separately provided, thereby making it possible to minimize power consumption and tilt phenomenon of the lens barrel and improve driving reliability.

In addition, according to the present invention, the preload part is removed, thereby making it possible to simplify the structure and the manufacturing process thereof.

In addition, the damping members are coupled to the lens barrel, thereby making it to possible to reduce vibration that may be generated when the lens barrel operates upward and downward.

Although the embodiments of the present invention has been disclosed for illustrative purposes, it will be appreciated that a camera module according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A camera module, comprising:
a lens barrel with a built-in lens collecting external images;
a housing that has a receiving space in which the lens barrel is received;
a driving part that is configured to include a magnet and a coil and provides a first driving force that drives the lens barrel upward and a second driving force that drives the lens barrel downward by an electromagnetic force that is generated from the magnet and the coil and wherein the lens barrel can start to be driven upward or downward by the driving part at any position in the receiving space of the housing;
a guide ball that is provided between the lens barrel and the housing and guides the motion of the lens barrel; and
a position detection part that senses the position of the lens barrel;
wherein damping members that reduce vibration of the lens barrel are formed on the upper end portion or the lower end portion of the lens barrel.

2. The camera module as set forth in claim 1, wherein a damping coupling part is further formed on the outer circumferential surface of the lens barrel in order to support the damping members.

3. The camera module as set forth in claim 1, wherein the driving part includes the coil that is mounted on the inner circumferential surface of the housing and generates an electric field when current is applied; and the magnet that is mounted on the outer circumferential surface of the lens barrel so as to be opposite to the coil and generates a magnetic field which interacts with the electric field.

4. The camera module as set forth in claim 1, wherein receiving grooves that rotatably support the guide ball are formed on the outer circumferential surface of the lens barrel and the inner circumferential surface of the housing.

5. The camera module as set forth in claim 1, wherein the position detection part is a hole sensor that senses the change in the position of the magnet.

6. The camera module as set forth in claim 1, further comprising a control part that calculates a focusing target position of the lens barrel from an image signal of an image sensor mounted on a circuit substrate having the housing attached and fixed on its upper surface, compares the focusing target position with a driving position of the lens barrel sensed by the position detection part, and controls power applied to the lens barrel.
